(19) United States
(12) Patent Application Publication
(10) Pub. No.: US 2008/0027737 A1
(43) Pub. Date: Jan. 31, 2008

(54) Shipping Price Protection

(76) Inventor: Alan Wayne Watkins, Raleigh, NC (US)

Correspondence Address: DILLON & YUDELL LLP, 8911 N. CAPITAL OF TEXAS HWY., SUITE 2110, AUSTIN, TX, 78759, US

(21) Appl. No.: 11/459,672

(22) Filed: Jul. 25, 2006

(51) Int. Cl. G06Q 10/00; G06Q 30/00

(52) U.S. Cl. 705/1

(57) ABSTRACT

A system is presented for establishing a shipping contract between a buyer and a shipper. A maximum price for shipping a buyer's order is established between a seller and a buyer. Based on this maximum price, an authorization number is created between the seller and a shipper, wherein the authorization number identifies the buyer's order and the agreed-upon maximum price. This authorization number is then transmitted to the buyer, who creates a contract between the buyer and the shipper to ship the buyer's order to the buyer. The contract between the buyer and the shipper may include a shipping fee surcharge, which may be disclosed or undisclosed to the buyer.

### BACKGROUND OF THE INVENTION

The present invention relates in general to the field of computers and other data processing systems, including hardware, software and processes. More particularly, the present invention pertains to establishing a shipping agreement among a shipping company, a seller and a buyer.

A problem when buying things online is that the buyer and seller are faced with a shipping dilemma. Specifically, the buyer doesn't want to be overcharged for shipping, and the seller doesn't want to lose money when shipping. There are several prior art solutions to this problem. One such solution is that a seller can ship an item COD (“Charge On Delivery”). The drawback to this is that there is no guarantee that the buyer will pay, and the seller would still be charged for shipping the item. Another solution is for the seller to contact a shipping company, calculate the exact cost to ship an item sold to a buyer, and to then charge the buyer accordingly. Unfortunately, this is time consuming and requires the seller to contact both the shipping company as well as the buyer, which is time consuming. Another solution is for the seller to weigh the item, and then to use online calculators to determine the correct price for shipping. The problem with this is solution is that the sellers often overestimate the weight of the item, in order to be sure that the buyer is charged enough for shipping. Unfortunately, this puts the buyer at the disadvantage of being overcharged without recourse. In addition, it may not be feasible for a seller to accurately determine what the final shipping cost for a product will be considering packing materials, variables for different shipping methods and rates, etc.

Another problem for buyers is that sellers sometimes try to hide profits in shipping charges by greatly overcharging for shipping, instead of charging an accurate shipping charge and an accurate price for the item sold. Underpricing the item sold is deceptive to the buyer. Furthermore, in the event of on-line auctions, underpricing hurts the auction site, which normally takes a cut from the final value price (exclusive of shipping costs).

### SUMMARY OF THE INVENTION

To address the problems described above, the present invention presents a computer-implementable method, system and computer media for establishing a shipping contract between a buyer and a shipper according to agreed-upon parameters set by a seller and the buyer. In one embodiment, the computer-implementable method includes the steps of establishing, between a seller and a buyer, a maximum price for shipping a buyer's order; creating an authorization number between the seller and a shipper, wherein the authorization number identifies the buyer's order and includes the maximum price authorized for shipping the buyer's order; transmitting the authorization number to the buyer; and creating a contract between the buyer and the shipper to ship the buyer's order to the buyer. The authorization number may be transmitted to the buyer from the seller and/or the shipper. The contract between the buyer and the shipper may include a buyer-selected option for a shipping method and other shipping parameters, such as insurance, packaging, tracking options, etc. The contract between the buyer and the shipper may include a shipping fee surcharge, wherein the shipping fee surcharge is an add-on charge to a standard shipping charge that is charged by the shipper. This shipping fee surcharge may be disclosed or undisclosed to the buyer. In one embodiment, the contract between the buyer and shipper is formed by assigning a seller's rights, in another contract between the seller and the shipper, to the buyer.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a diagram of a relationships between, and steps taken by, a Seller, a Buyer and a Shipper in accordance with the present invention;

FIG. 2 is a flow-chart of exemplary steps taken in the present invention to permit a Buyer to directly negotiate shipping terms with the Seller and the Shipper;

FIG. 3 depicts an exemplary client computer in which the present invention may implemented;

FIG. 4 illustrates an exemplary server from which software for executing the present invention may be deployed and/or implemented for the benefit of a user of the client computer shown in FIG. 3;

FIGS. 5a-b show a flow-chart of steps taken to deploy software capable of executing the steps shown and described in FIGS. 1-2;

FIGS. 6a-b show a flow-chart showing steps taken to execute the steps shown and described in FIGS. 1-2 using an on-demand service provider; and

FIGS. 7a-b illustrate a process for utilizing one or more rules to invoke the methods described by the present invention, including but not limited to the steps described in FIGS. 1-2.

### DETAILED DESCRIPTION OF THE PREFERRED EMBODIMENT

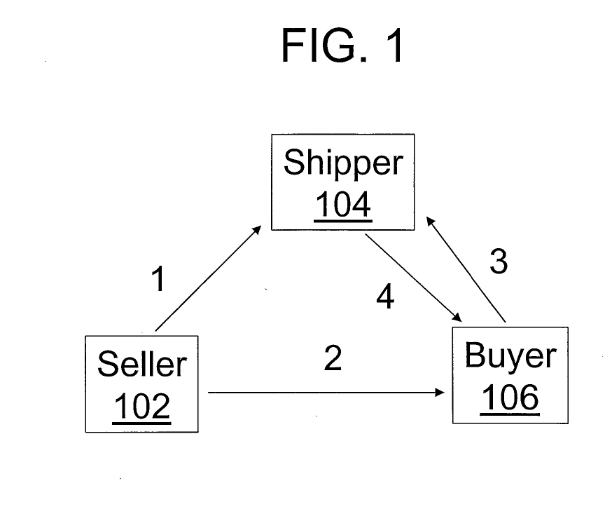

With reference now to the figures, and in particular to FIG. 1, a simplified diagram of parties to a shipment, including actions taken as contemplated by the present invention, is presented. At Step 1, a seller 102 logs into a website hosted by a shipper 104 (or, alternatively, contacts shipper 104 in some other manner) to obtain an authorization code for a buyer's order placed by a buyer 106. This authorization code identifies the maximum authorized shipping cost for the buyer's order (including any shipping cost surcharges charged by the shipper 104 and/or the seller 102 for billing the shipping costs to the buyer 106 via the authorization code). For example, seller 102 may obtain an authorization code #12345 for a $20 maximum shipping charge. In one embodiment, this $20 maximum shipping charge is associated with a specific order placed by the buyer (“buyer's order”). In order to obtain the authorization code, the seller 102 and shipper 104 preferably have previously established an account, in which the seller 102 can request such authorization codes. The account may also establish other parameters available to the seller 102 for other orders placed by buyers 106. These parameters may include the availability and pricing for insurance, packing, delivery confirmation, tracking number availability, whether the buyer 106 will pay for the shipping costs directly to the shipper 104, though the seller 102, or via a third party payment service such as PayPal®.

At Step 2, the seller 102 sends the authorization code to the buyer 106. At Step 3, the buyer 106 logs into the website managed by the shipper 104, and enters (validates) the authorization code received from the seller 102. This causes the shipper 104 to present, through its website, parameters set by the seller 102 for that particular authorization code. These parameters may be set by either the seller 102 or the buyer 106. For example, the maximum amount to be charged has been previously fixed by the seller 102 and buyer 106, and thus does not change. Similarly, the weight of the buyer's order (which is supplied by the seller 102 either through a message sent from the seller 102 to shipper 104, or by the seller 102 physically delivering the buyer's order to the shipper 104 for weighing and/or packaging), is also fixed. Based on this weight, a base shipping charge is calculated by the shipper 104 and presented to the buyer 106 via the shipper's website. Via this website, however, are variable options that are authorized according to an agreement and/or account set up between the seller 102 and the shipper 104. That is, it is preferable for the seller 102 to control the availability of expensive options such as overnight delivery, special packing (if done by the shipper), etc. in order to ensure that the maximum amount agreed upon by the seller 102 and the buyer 106 is not exceeded. Thus, based on options available to the buyer 106, the buyer 106 selects (within the example's $20 budget) delivery, tracking, packing and other options from the webpage of shipper 104 for the particular authorization code received from the seller 102. Note that the shipper 104 and/or seller 102 may include a surcharge fee on top of the basic shipping charge. This surcharge fee covers the administrative cost of allowing the buyer to directly pay for shipping in accordance with the procedure described in the present invention, and will therefore primarily be owed to the shipper 104. This surcharge may be disclosed or undisclosed (“buried” in the base shipping charge) to the buyer 106. Note that in a preferred embodiment of the present invention, this surcharge is directly attributed to the fee for handling the contract between the buyer and the shipper, and does not include any “buried” excess profit for the shipper and/or seller. Thus, the buyer can see the exact shipping cost charged by the shipper, plus the exact cost of the surcharge from the shipper (and/or seller).

At Step 4, the shipper 104 ships the buyer's order to the buyer 106. The shipper completes the transaction by charging the shipping to the buyer 106. The buyer 106 pays this shipping charge either directly to the shipper 104 (e.g., with a credit card), via the seller 102 (by including the shipping charge when paying the seller 102 for the goods in the buyer's order), or through a third party payment service (such as PayPal®).

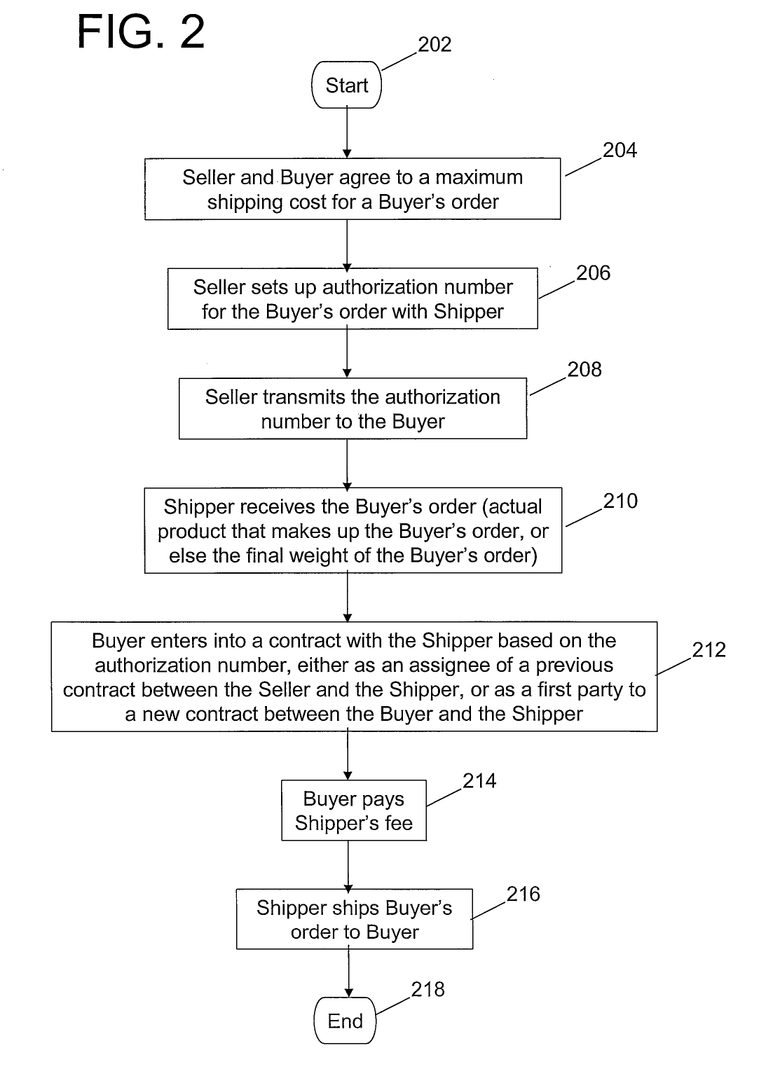

With reference now to FIG. 2, additional detail of exemplary steps taken in the present invention is presented. After initiator block 202, a seller and buyer agree upon a maximum shipping cost for a buyer's order (block 204). The seller then sets up an authorization number with a shipper for the buyer's order (block 206). This authorization number will include the maximum amount that the shipper can charge, as well as what shipping options are available to the buyer. The seller then transmits this authorization number to the buyer (block 208). As indicated in block 210, the shipper receives information regarding the weight of the buyer's order. This information may be sent from the seller to the shipper, or else the seller may send the actual goods in the buyer's order to the shipper, who can weigh the goods. The buyer then enters into a contract with the shipper to ship the goods to the buyer (block 212). This contract may be a first-party contract that is formed between the buyer and the shipper, or else the buyer may act as an assignee to a contract previously formed between the seller and the shipper when the authorization number was received. That is, when the seller obtains the authorization number from the shipper, the seller and shipper can form a contract at that time, in which the shipper agrees to ship the buyer's goods in a certain manner for a specified price. The buyer can then assume the contractual role of the seller as an assignee to the contract, or through assumption of the contract based on that specific authorization number. Once the shipper receives payment (or a promise of payment) from the buyer (block 214), the shipper ships the buyer's order to the buyer (block 216) and the process ends (terminator block 218).

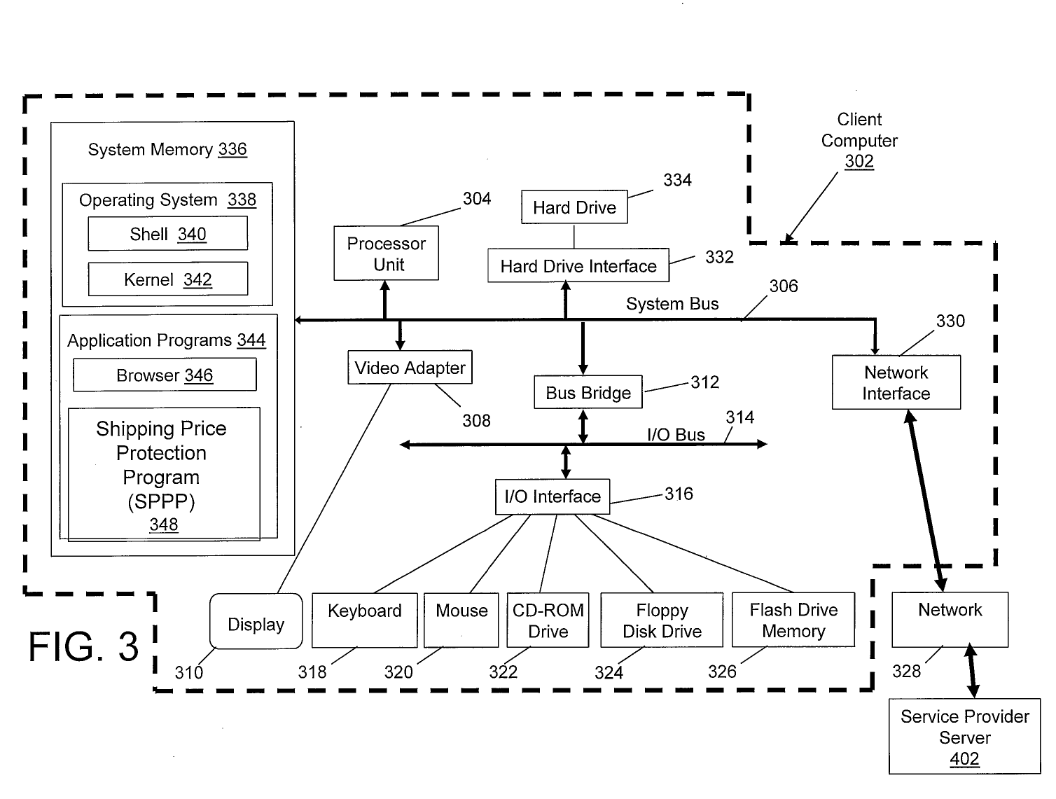

With reference now to FIG. 3, there is depicted a block diagram of an exemplary client computer 302, in which the present invention may be utilized by the shipper 104, seller 102, and/or buyer 106 shown in FIG. 1. Client computer 302 includes a processor unit 304 that is coupled to a system bus 306. A video adapter 308, which drives/supports a display 310, is also coupled to system bus 306. System bus 306 is coupled via a bus bridge 312 to an Input/Output (I/O) bus 314. An I/O interface 316 is coupled to I/O bus 314. I/O interface 316 affords communication with various I/O devices, including a keyboard 318, a mouse 320, a Compact Disk-Read Only Memory (CD-ROM) drive 322, a floppy disk drive 324, and a flash drive memory 326. The format of the ports connected to I/O interface 316 may be any known to those skilled in the art of computer architecture, including but not limited to Universal Serial Bus (USB) ports.

Client computer 302 is able to communicate with a service provider server 402 via a network 328 using a network interface 330, which is coupled to system bus 306. Network 328 may be an external network such as the Internet, or an internal network such as an Ethernet or a Virtual Private Network (VPN). Using network 328, client computer 302 is able to use the present invention to access service provider server 402.

A hard drive interface 332 is also coupled to system bus 306. Hard drive interface 332 interfaces with a hard drive 334. In a preferred embodiment, hard drive 334 populates a system memory 336, which is also coupled to system bus 306. System memory 336 is defined as a lowest level of volatile memory in client computer 302. This volatile memory may include additional higher levels of volatile memory (not shown), including, but not limited to, cache memory, registers and buffers. Data that populates system memory 336 includes client computer 302's operating system (OS) 338 and application programs 344.

OS 338 includes a shell 340, for providing transparent user access to resources such as application programs 344. Generally, shell 340 is a program that provides an interpreter and an interface between the user and the operating system. More specifically, shell 340 executes commands that are entered into a command line user interface or from a file. Thus, shell 340 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 342) for processing. Note that while shell 340 is a text-based, line-oriented user interface, the present invention will equally well support other user interface modes, such as graphical, voice, gestural, etc.

As depicted, OS 338 also includes kernel 342, which includes lower levels of functionality for OS 338, including providing essential services required by other parts of OS 338 and application programs 344, including memory management, process and task management, disk management, and mouse and keyboard management.

Application programs 344 include a browser 346. Browser 346 includes program modules and instructions enabling a World Wide Web (Www) client (i.e., client computer 302) to send and receive network messages to the Internet using HyperText Transfer Protocol (HTTP) messaging, thus enabling communication with service provider server 402.

Application programs 344 in client computer 302's system memory 336 also include a Shipping Price Protection Program (SPPP) 348, which includes code for implementing the processes described in FIGS. 1-2. In one embodiment, client computer 302 is able to download SPPP 348 from service provider server 402.

The hardware elements depicted in client computer 302 are not intended to be exhaustive, but rather are representative to highlight essential components required by the present invention. For instance, client computer 302 may include alternate memory storage devices such as magnetic cassettes, Digital Versatile Disks (DVDs), Bernoulli cartridges, and the like. These and other variations are intended to be within the spirit and scope of the present invention.

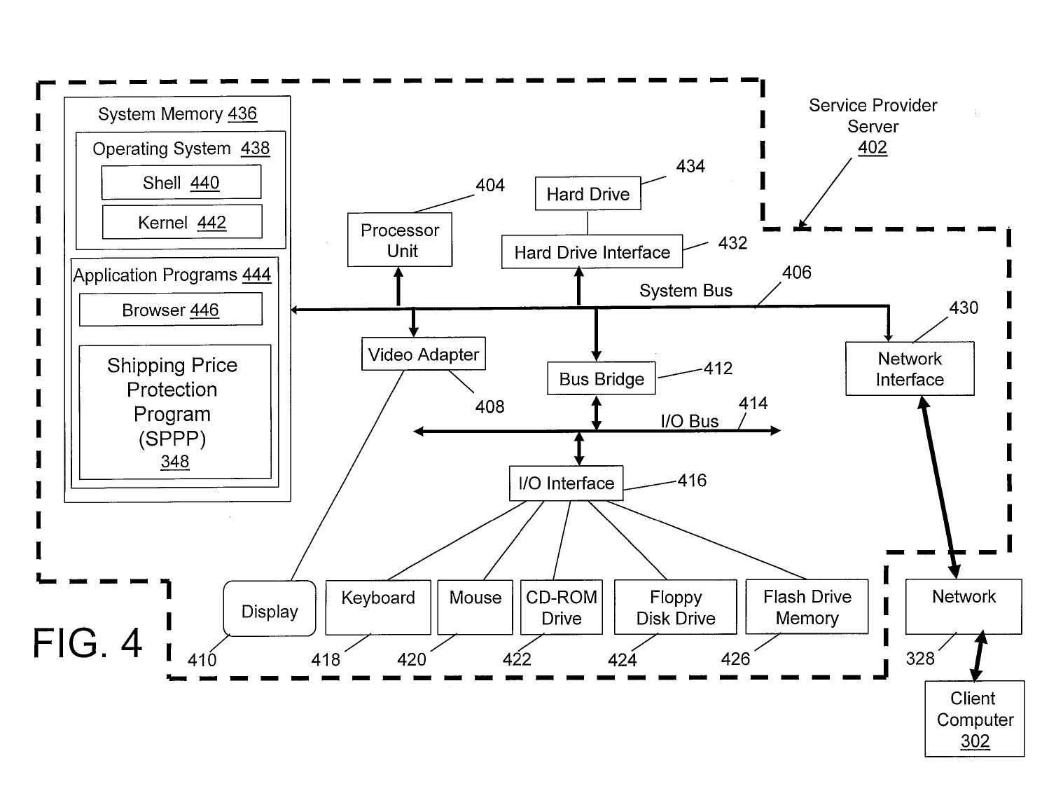

As noted above, SPPP 348 can be downloaded to client computer 302 from service provider server 402, shown in exemplary form in FIG. 4. Service provider server 402 includes a processor unit 404 that is coupled to a system bus 406. A video adapter 408 is also coupled to system bus 406. Video adapter 408 drives/supports a display 410. System bus 406 is coupled via a bus bridge 412 to an Input/Output (I/O) bus 414. An I/O interface 416 is coupled to I/O bus 414. I/O interface 416 affords communication with various I/O devices, including a keyboard 418, a mouse 420, a Compact Disk-Read Only Memory (CD-ROM) drive 422, a floppy disk drive 424, and a flash drive memory 426. The format of the ports connected to I/O interface 416 may be any known to those skilled in the art of computer architecture, including but not limited to Universal Serial Bus (USB) ports.

Service provider server 402 is able to communicate with client computer 302 via network 328 using a network interface 430, which is coupled to system bus 406. Access to network 328 allows service provider server 402 to execute and/or download SPPP 348 to client computer 302.

System bus 406 is also coupled to a hard drive interface 432, which interfaces with a hard drive 434. In a preferred embodiment, hard drive 434 populates a system memory 436, which is also coupled to system bus 406. Data that populates system memory 436 includes service provider server 402's operating system 438, which includes a shell 440 and a kernel 442. Shell 440 is incorporated in a higher level operating system layer and utilized for providing transparent user access to resources such as application programs 444, which include a browser 446, and a copy of SPPP 348 described above, which can be deployed to client computer 302.

The hardware elements depicted in service provider server 402 are not intended to be exhaustive, but rather are representative to highlight essential components required by the present invention. For instance, service provider server 402 may include alternate memory storage devices such as flash drives, magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 402 performs all of the functions associated with the present invention (including execution of SPPP 348), thus freeing client computer 302 from using its resources.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

### Software Deployment

As described above, in one embodiment, the processes described by the present invention, including the functions of SPPP 348, are performed by service provider server 402. Alternatively, SPPP 348 and the method described herein, and in particular as shown and described in FIGS. 1-2, can be deployed as a process software from service provider server 402 to client computer 302. Still more particularly, process software for the method so described may be deployed to service provider server 402 by another service provider server (not shown).

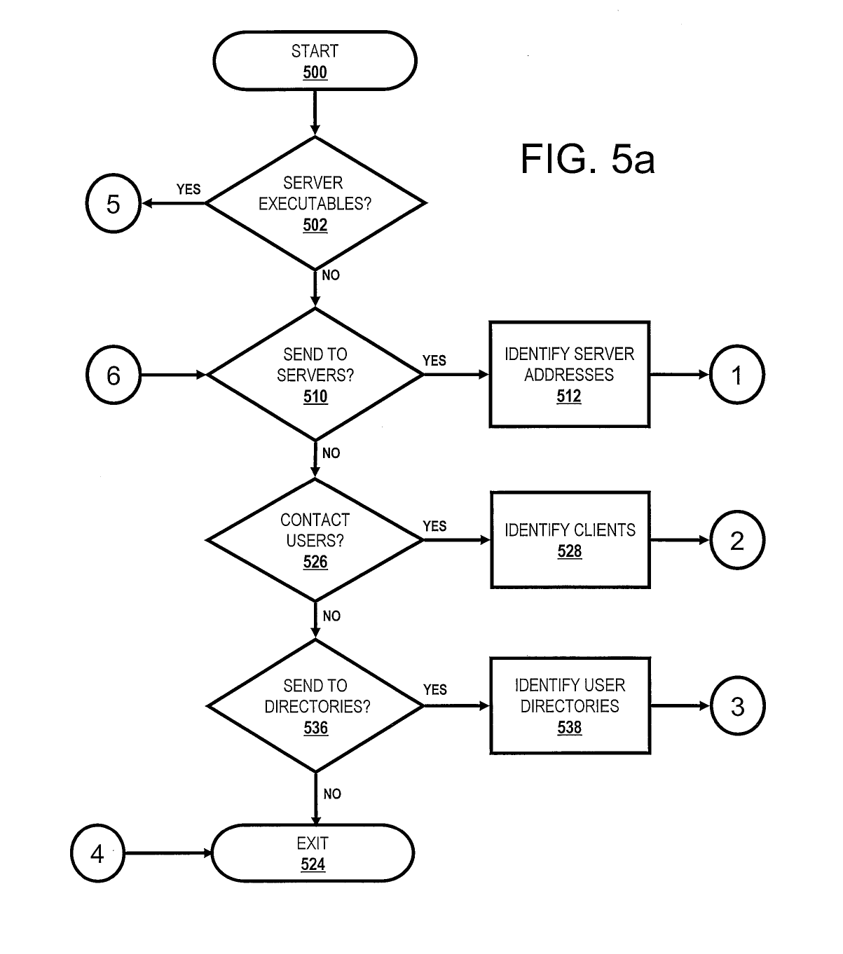

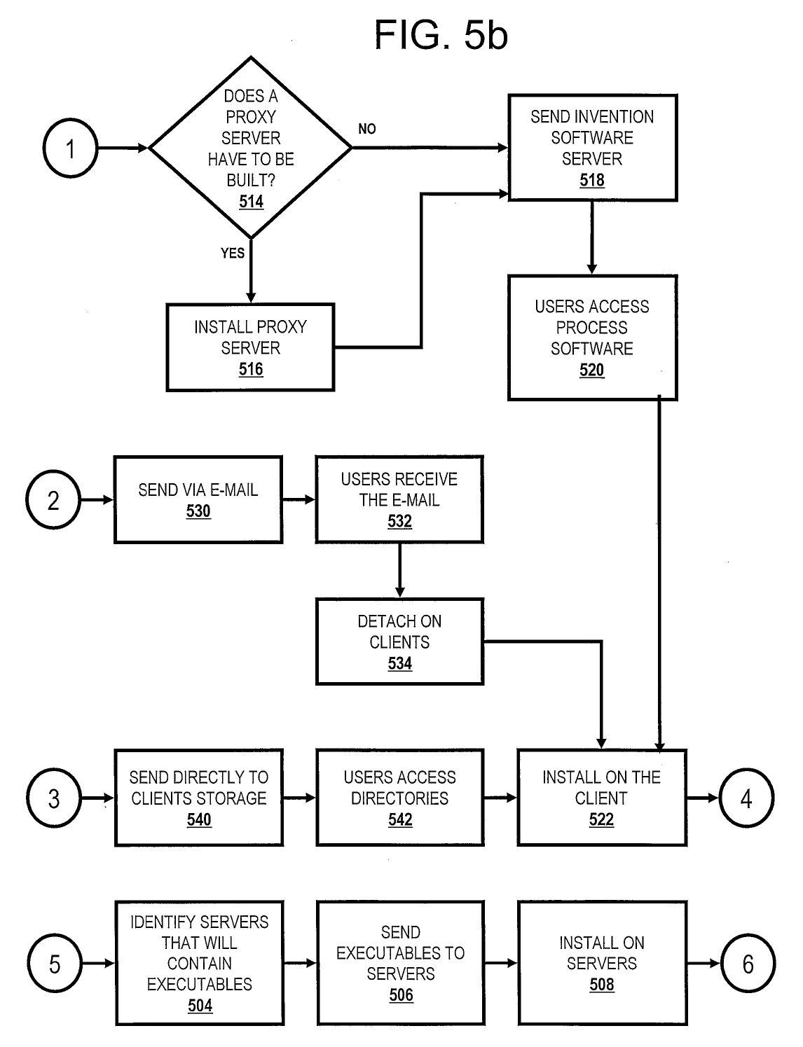

Referring then to FIGS. 5a-b, step 500 begins the deployment of the process software. The first thing is to determine if there are any programs that will reside on a server or servers when the process software is executed (query block 502). If this is the case, then the servers that will contain the executables are identified (block 504). The process software for the server or servers is transferred directly to the servers' storage via File Transfer Protocol (FTP) or some other protocol or by copying though the use of a shared file system (block 506). The process software is then installed on the servers (block 508).

Next, a determination is made on whether the process software is to be deployed by having users access the process software on a server or servers (query block 510). If the users are to access the process software on servers, then the server addresses that will store the process software are identified (block 512).

A determination is made if a proxy server is to be built (query block 514) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 516). The process software is sent to the servers either via a protocol such as FTP or it is copied directly from the source files to the server files via file sharing (block 518). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (block 520). Another embodiment is to have the servers automatically copy the process software to each client and then run the installation program for the process software at each client computer. The user executes the program that installs the process software on his client computer (block 522) then exits the process (terminator block 524).

In query step 526, a determination is made whether the process software is to be deployed by sending the process software to users via e-mail. The set of users where the process software will be deployed are identified together with the addresses of the user client computers (block 528). The process software is sent via e-mail to each of the users' client computers (block 530). The users then receive the e-mail (block 532) and then detach the process software from the e-mail to a directory on their client computers (block 534). The user executes the program that installs the process software on his client computer (block 522) then exits the process (terminator block 524).

Lastly a determination is made as to whether the process software will be sent directly to user directories on their client computers (query block 536). If so, the user directories are identified (block 538). The process software is transferred directly to the user's client computer directory (block 540). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 542). The user executes the program that installs the process software on his client computer (block 522) and then exits the process (terminator block 524).

### VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called runnel interfaces, where the packet enters and exits the network.

### Software Integration

The process software which consists code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists match the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

### On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory utilization, storage utilization, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory utilization, storage utilization, etc. approach a capacity so as to affect performance, additional network bandwidth, memory utilization, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

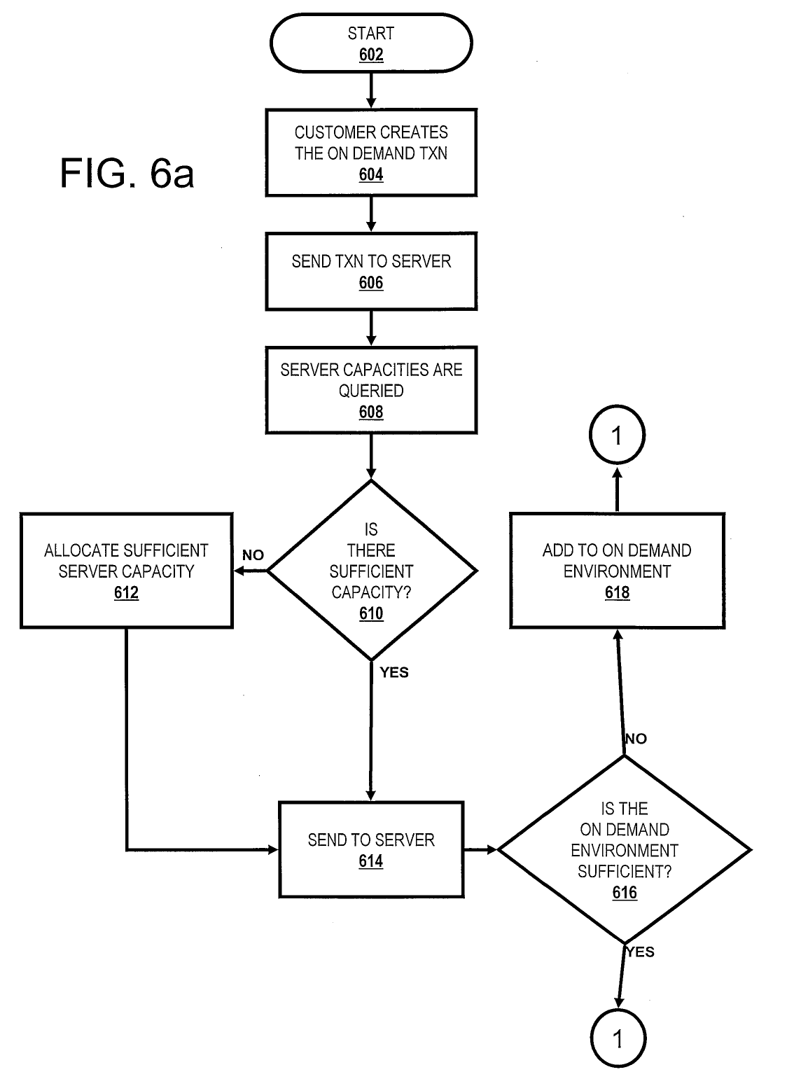

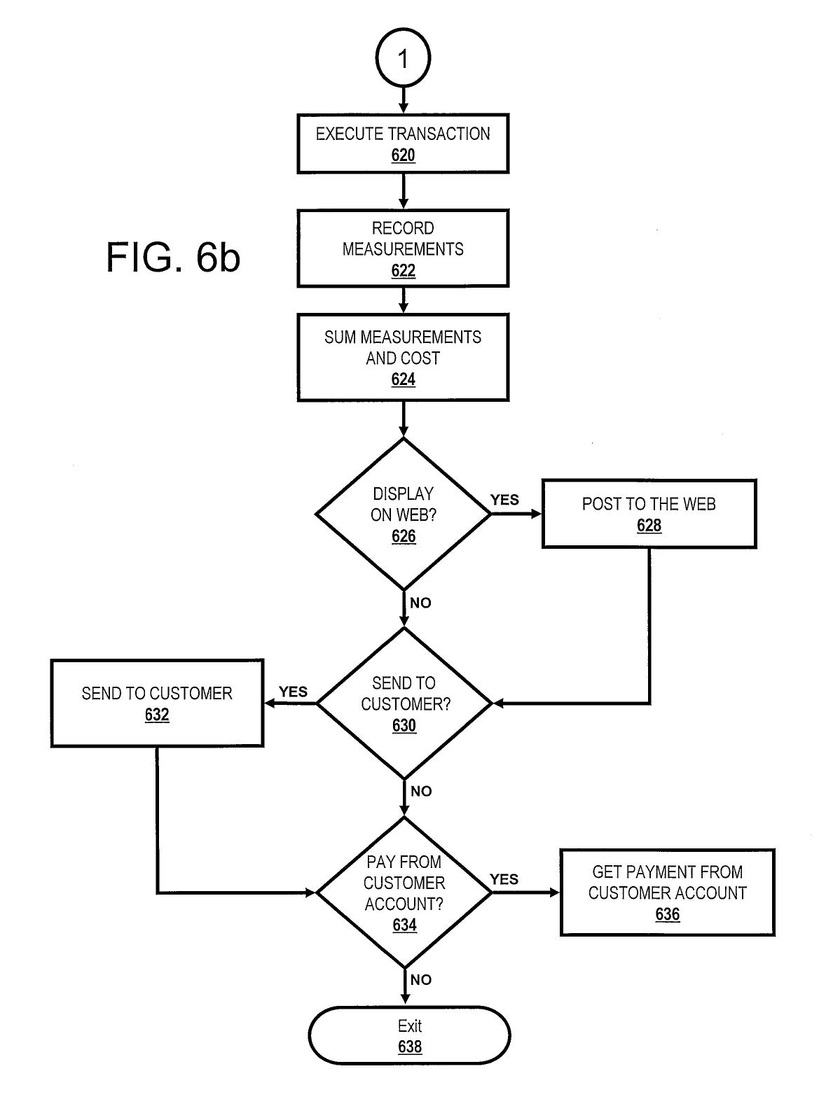

With reference now to FIGS. 6a-b, initiator block 602 begins the On Demand process. A transaction is created than contains the unique customer identification, the requested service type and any service parameters that further, specify the type of service (block 604). The transaction is then sent to the main server (block 606). In an On Demand environment the main server can initially be the only server, then as capacity is consumed other servers are added to the On Demand environment.

The server central processing unit (CPU) capacities in the On Demand environment are queried (block 608). The CPU requirement of the transaction is estimated, then the servers available CPU capacity in the On Demand environment are compared to the transaction CPU requirement to see if there is sufficient CPU available capacity in any server to process the transaction (query block 610). If there is not sufficient server CPU available capacity, then additional server CPU capacity is allocated to process the transaction (block 612). If there was already sufficient Available CPU capacity then the transaction is sent to a selected server (block 614).

Before executing the transaction, a check is made of the remaining On Demand environment to determine if the environment has sufficient available capacity for processing the transaction. This environment capacity consists of such things as but not limited to network bandwidth, processor memory, storage etc. (block 616). If there is not sufficient available capacity, then capacity will be added to the On Demand environment (block 618). Next the required software to process the transaction is accessed, loaded into memory, then the transaction is executed (block 620).

The usage measurements are recorded (block 622). The utilization measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 624).

If the customer has requested that the On Demand costs be posted to a web site (query block 626), then they are posted (block 628). If the customer has requested that the On Demand costs be sent via e-mail to a customer address (query block 630), then these costs are sent to the customer (block 632). If the customer has requested that the

On Demand costs be paid directly from a customer account (query block 634), then payment is received directly from the customer account (block 636). The On Demand process is then exited at terminator block 638.

### Method Invoking Rules

The methods described herein may be invoked by one or more rules. These rules may be specific for a resource, a network, an enterprise, or any other resource partition at any granularity. The rule can optionally be initiated by a policy. Resources are defined to include hardware as well as software resources.

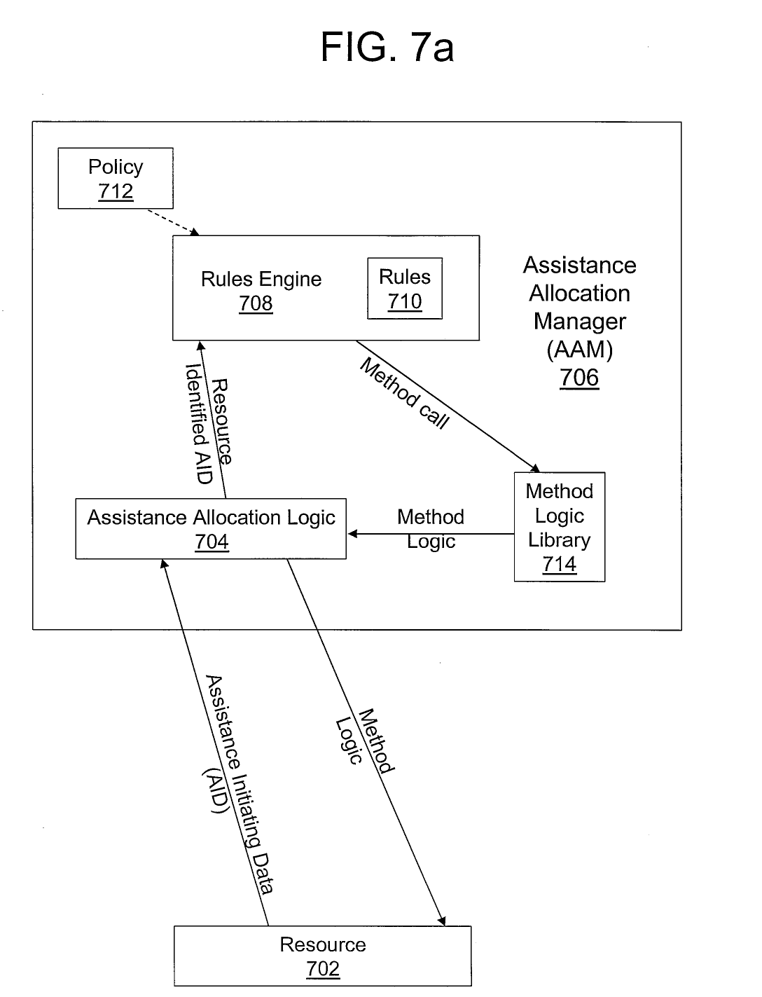

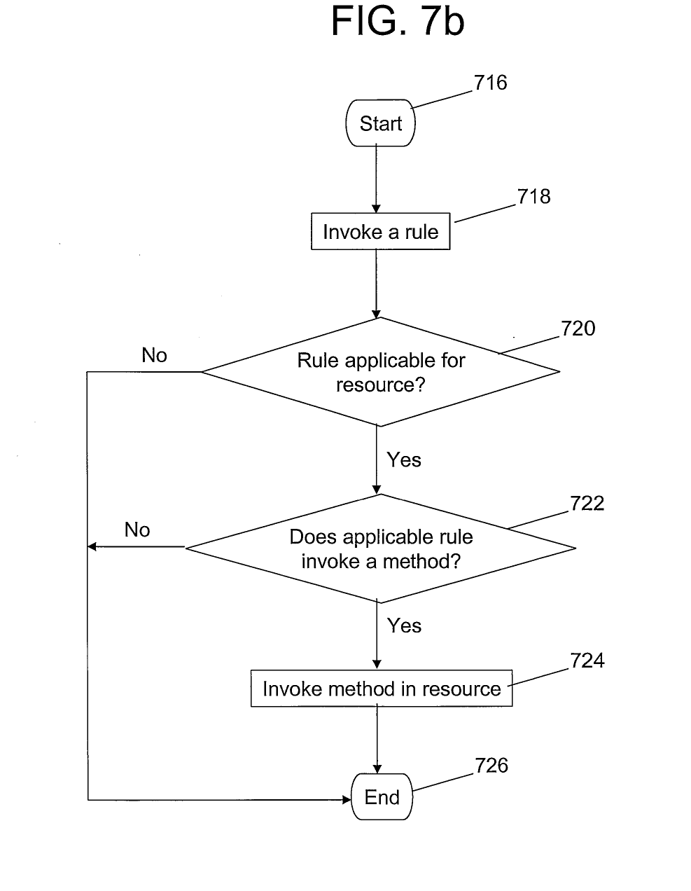

For example, consider the infrastructure and process shown in FIG. 7a. A resource 702, such as client computer 302 or a service provider server 402, sends an Assistance Initiating Data (AID) to an Assistance Allocation Logic (AAL) 704 in an Assistance Allocation Manager (AAM). The AID may be a request for another resource, such as a particular Webpage, portal resource (including portlets, etc.), control instructions, etc. The AID may also be performance data that is pushed or pulled from the resource 702. For example, resource 702 may issue an AID requesting delivery of web content, execution of a server-based application, access to a particular website or a particular software resource, including an application, a method/class, a portlet, etc. Alternatively, the AID may be performance data, such as data that describes CPU usage, clock speed, hardware temperature, the number of users (actual or allocated) of the resource, etc. Such examples of types of AID are exemplary only, and are not to limit the scope of the definition of an AID.

When AAL 704 receives an AID, AAL 704 recognizes the type of AID and the identifier for the resource that sent the AID. The AID may directly contain a type indicator (indicating that the AID is for a request for resource(s), performance data, etc.) as well as an identifier for the AID-sending resource, or the AID may be linked to metadata that supplies such information. This information (the AID plus the identifier for the specific resource 702 that sent the AID) is forwarded from the AAL 704 to a rules engine 708, which includes a library of rules 710. Note that the rules 710 may be initiated by and responsive to a policy 712. Policy 712 may be formulated by a person or software logic associated with AAM 706, the resource 702, or any other entity having authority to influence the formulation of the rules 710.

Rules engine 708, by executing a particular rule 710 for the resource-associated AID, issues a message to a method logic library 714. This message instructs the method logic library 714 to access a particular method logic—which implements in software, hardware, or a combination thereof, a novel method as described above in the foregoing figures. The ALL 704 forwards this method logic to the resource 702, which implements the inventive and novel method under the control of the particular rule from the library of rules 710.

With reference now to FIG. 7b, a flow-chart of exemplary steps taken to invoke a method by a rule is presented. After initiator block 716, a rule is invoked 718. This rule may be invoked in response to a message from a resource, or the rule may be invoked autonomously by an Assistance Allocation Manager (AAM). The AAM may be a web-based service, such as that offered by IBM® Global Services® (IGS™), using a Service Oriented Architecture (SOA) software service such as IBM's Websphere®. The SOA software includes a bottom level of applications (pieces of code that perform some useful function), a middle level of Web services (infrastructure for accessing the applications), and a top layer of business processes (steps taken to call the Web services). Thus, in a preferred embodiment, the AAM is a third party service that manages resources for a customer.

Continuing with FIG. 7b, a query is made of the invoked rule to determine and/or confirm that the invoked rule is applicable to a particular resource (block 720). If so, then a determination is made regarding which method is called by the invoked rule (block 722). The appropriate method is then called and implemented in the appropriate resource (block 724), and the process ends (terminator block 726).

The present invention thus presents a computer-implementable method, system and computer media for establishing a shipping contract between a buyer and a shipper. In one embodiment, the computer-implementable method includes the steps of establishing, between a seller and a buyer, a maximum price for shipping a buyer's order; creating an authorization number between the seller and a shipper, wherein the authorization number identifies the buyer's order and includes the maximum price authorized for shipping the buyer's order; transmitting the authorization number to the buyer; and creating a contract between the buyer and the shipper to ship the buyer's order to the buyer. The authorization number may be transmitted to the buyer from the seller and/or the shipper. The contract between the buyer and the shipper may include a buyer-selected option for a shipping method. The contract between the buyer and the shipper may include a shipping fee surcharge, wherein the shipping fee surcharge is an add-on charge to a standard shipping charge that is charged by the shipper. This shipping fee surcharge may be disclosed or undisclosed to the buyer. In one embodiment, the contract between the buyer and shipper is formed by assigning a seller's rights, in another contract between the seller and the shipper, to the buyer. In another embodiment, the method includes the additional steps of receiving, by an Assistance Allocation Manager (AAM), an Assistance Initiating Data (AID) from a resource in a data processing system; and invoking a rule, in the AAM, that is specific for the AID and the resource that sent the AID, wherein invoking the rule in the AAM causes the steps described herein to be executed in the resource that sent the AID.

Note further that, as described above, instructions used in each embodiment of a computer-usable medium may be deployed from a service provider to a user. This deployment may be made in an “on-demand” basis as described herein.

As described herein, the present invention is advantageous to the seller, buyer and shipper. That is, the seller does not have to put any additional money out for shipping. The seller also has confirmation that the buyer has agreed to the method/parameters of shipping (parcel post, delivery confirmation, etc). Furthermore, the shipper may be willing to give additional incentives to the seller through some type of loyal customer program. Thus, the shipper could compete with some of the online versions of money transfers, and possibly charge a reduced percentage, which would benefit the seller as well.

The shipper benefits through the gain of additional revenue through fees (fee can be a percentage of the price or flat fee). The shipper also gains customer loyalty, since there are less lost pseudo-revenues to sellers who overcharge for shipping. Alliances may be formed with auction sites that encourage buyers to use their shipping company. Also, there is less likelihood that the buyer will later complain about the buyer not providing something such as delivery confirmation or tracking, since this is now be part of the contract between the buyer/seller and shipper.

The buyer benefits through cheaper shipping, since the buyer is paying closer to the actual price. Also, the buyer is guaranteed to be paying the actual shipping price plus a small fee (surcharge). Also, the buyer is assured, through the online contract with the shipper, that the seller is using the shipping (and packing) options that the buyer chooses, such as delivery confirmation, insurance, etc.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implementable method for establishing a shipping contract, the computer-implementable method comprising:
establishing, between a seller and a buyer, a maximum price for shipping a buyer's order;
creating an authorization number between the seller and a shipper, wherein the authorization number identifies the buyer's order and includes the maximum price authorized for shipping the buyer's order;
transmitting the authorization number to the buyer; and
creating a contract, based on the authorization number, between the buyer and the shipper to ship the buyer's order to the buyer.

2. The computer-implementable method of claim 1, wherein the contract between the buyer and the shipper includes a buyer-selected option for a shipping method.

3. The computer-implementable method of claim 1, wherein the contract between the buyer and the shipper includes a shipping fee surcharge, wherein the shipping fee surcharge is an add-on charge to a standard shipping charge that is charged by the shipper.

4. The computer-implementable method of claim 3, wherein the shipping fee surcharge is disclosed to the buyer.

5. The computer-implementable method of claim 3, wherein the shipping fee surcharge is hidden from the buyer.

6. The computer-implementable method of claim 1, wherein the contract between the buyer and shipper is formed by assigning a seller's rights, in another contract between the seller and the shipper, to the buyer.

7. The computer-implementable method of claim 1, wherein the authorization number is transmitted to the buyer from the seller.

8. The computer-implementable method of claim 1, wherein the authorization number is transmitted to the buyer from the shipper.

9. The method of claim 1, further comprising:
receiving, by an Assistance Allocation Manager (AAM), an Assistance Initiating Data (AID) from a resource in a data processing system; and
invoking a rule, in the AAM, that is specific for the AID and the resource that sent the AID, wherein invoking the rule in the AAM causes the steps described in claim 1 to be executed in the resource that sent the AID.

10. A system comprising:
a processor;
a data bus coupled to the processor;
a memory coupled to the data bus; and
a computer-usable medium embodying computer program code, the computer program code comprising instructions executable by the processor and configured for:
establishing, between a seller and a buyer, a maximum price for shipping a buyer's order;
creating an authorization number between the seller and a shipper, wherein the authorization number identifies the buyer's order and includes the maximum price authorized for shipping the buyer's order;
transmitting the authorization number to the buyer; and
creating a contract between the buyer and the shipper to ship the buyer's order to the buyer.

11. The system of claim 10, wherein the contract between the buyer and the shipper includes a shipping fee surcharge, wherein the shipping fee surcharge is an add-on charge to a standard shipping charge that is charged by the shipper.

12. A computer-usable medium embodying computer program code, the computer program code comprising computer executable instructions configured for:
establishing, between a seller and a buyer, a maximum price for shipping a buyer's order;
creating an authorization number between the seller and a shipper, wherein the authorization number identifies the buyer's order and includes the maximum price authorized for shipping the buyer's order;
transmitting the authorization number to the buyer; and
creating a contract between the buyer and the shipper to ship the buyer's order to the buyer.

13. The computer-usable medium of claim 12, wherein the contract between the buyer and the shipper includes a buyer-selected option for a shipping method.

14. The computer-usable medium of claim 12, wherein the contract between the buyer and the shipper includes a shipping fee surcharge, wherein the shipping fee surcharge is an add-on charge to a standard shipping charge that is charged by the shipper.

15. The computer-usable medium of claim 14, wherein the shipping fee surcharge is disclosed to the buyer.

16. The computer-usable medium of claim 14, wherein the shipping fee surcharge is not disclosed to the buyer.

17. The computer-usable medium of claim 12, wherein the contract between the buyer and shipper is formed by assigning a seller's rights, in another contract between the seller and the shipper, to the buyer.

18. The computer-usable medium of claim 12, wherein the computer executable instructions are further configured for:
receiving, by an Assistance Allocation Manager (AAM), an Assistance Initiating Data (AID) from a resource in a data processing system; and
invoking a rule, in the AAM, that is specific for the AID and the resource that sent the AID, wherein invoking the rule in the AAM causes the steps described in claim 1 to be executed in the resource that sent the AID.

19. The computer-useable medium of claim 12, wherein the computer executable instructions are deployable to a client computer from a server at a remote location.

20. The computer-useable medium of claim 12, wherein the computer executable instructions are provided by a service provider to a customer on an on-demand basis.
